(19) United States
(12) Patent Application Publication
(10) Pub. No.: US 2024/0377525 A1
(43) Pub. Date: Nov. 14, 2024

(54) RADAR CONTROL DEVICE AND METHOD

(71) Applicant: HL Klemove Corp., Incheon (KR)

(72) Inventor: Ohcheol HEO, Incheon (KR)

(21) Appl. No.: 18/440,042

(22) Filed: Feb. 13, 2024

(30) Foreign Application Priority Data
Mar. 8, 2023 (KR) 10-2023-0030565

(51) Int. Cl. G01S 13/60; G01S 13/52; G01S 13/931

(52) U.S. Cl. CPC G01S 13/60; G01S 13/52; G01S 13/931

(57) ABSTRACT

The disclosure relates to a radar control device and method. Specifically, a radar control device according to the disclosure comprises a receiver receiving reception information obtained by detecting an object around a host vehicle, a producer detecting a measurement based on the reception information, classifying the measurement as a moving object and a stationary object, and performing a curve fitting on the stationary object to produce a first path, and an estimator estimating a vehicle driving path based on the first path.

### CROSS-REFERENCE TO RELATED APPLICATION

This application claims priority from Korean Patent Application No. 10-2023-0030565, filed on Mar. 8, 2023, which is incorporated herein by reference in its entirety.

### BACKGROUND

### Field

The present embodiments relate to a radar control device and method.

### Description of Related Art

Recently, vehicles equipped with radar are increasing. The electronic control unit (ECU) of the vehicle may calculate the distance, relative velocity and angle between a vehicle or an ambient object and the host vehicle based on the information output from the radar installed in the vehicle.

As such, a radar-equipped vehicle may provide various safety and convenience functions using, e.g., the distance, relative velocity, and angle between a vehicle or an ambient object and the host vehicle.

For example, the parking collision-avoidance Assist (PCA) function, smart cruise control (SCC) function, or smart parking assist system (SPAS) may be achieved by identifying the distance, relative velocity, and angle between a vehicle or an ambient object and the host vehicle using information input from a radar mounted to the vehicle.

Meanwhile, the smart cruise control function may detect the control target using an image sensor such as a camera and automatically control the velocity to keep a constant distance from the control target. In this case, if the control target drives in a curve, detection by the image sensor may fail, so that the smart cruise control function may not remain.

### BRIEF SUMMARY

In the foregoing background, there is provided a radar control device and method for maintaining a control target by producing a vehicle driving path reflecting a curved road even when a set control target enters the curved road.

To achieve the foregoing objectives, in an aspect, the disclosure provides a radar control device comprising a receiver receiving reception information obtained by detecting an object around a host vehicle, a producer detecting a measurement based on the reception information, classifying the measurement as a moving object and a stationary object, and performing a curve fitting on the stationary object to produce a first path, and an estimator estimating a vehicle driving path based on the first path.

In another aspect, the disclosure provides a radar control method comprising a detection information receiving step receiving reception information obtained by detecting an object around a host vehicle, a path producing step detecting a measurement based on the reception information, classifying the measurement as a moving object and a stationary object, and performing a curve fitting on the stationary object to produce a first path, and a path estimating step estimating a vehicle driving path based on the first path.

According to the disclosure, the radar control device and method may set a preceding vehicle as a control target in a situation where accuracy of estimation of a vehicle driving path is deteriorated, such as in a long-distance curved road, only with a detection signal of a radar sensor.

### DESCRIPTION OF DRAWINGS

The above and other objects, features, and advantages of the disclosure will be more clearly understood from the following detailed description, taken in conjunction with the accompanying drawings, in which:

FIG. 1 is a block diagram schematically illustrating a radar control device according to an embodiment of the disclosure;

FIGS. 2 and 3 are views illustrating an example of maintaining a control target by a radar control device according to an embodiment;

FIG. 4 is a view illustrating an example of classifying a calculated measurement as a moving object and a stationary object according to an embodiment;

FIG. 5 is a view illustrating a determination result of a stationary object according to an embodiment;

FIG. 6 is a view illustrating a curve fitting according to an embodiment;

FIG. 7 is a view illustrating an example of producing a second path according to an embodiment;

FIG. 8 is a view illustrating an example of producing a first path included in an area divided by a second path according to an embodiment;

FIG. 9 is a view illustrating an example of producing a third path according to an embodiment;

FIG. 10 is a view illustrating an example of estimating a vehicle driving path according to an embodiment;

FIG. 11 is a flowchart illustrating a radar control method according to an embodiment of the disclosure; and

FIG. 12 is a flowchart illustrating, in greater detail, step S1120 according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

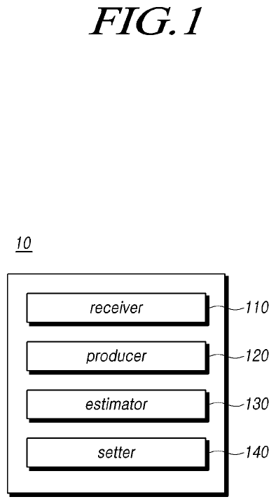

FIG. 1 is a block diagram schematically illustrating a radar control device 10 according to an embodiment of the disclosure.

The radar control device 10 according to the disclosure may include, e.g., a receiver 110, a producer 120, an estimator 130, and a setter 140.

In an embodiment, the radar control device 10 may be an advance driver assistance systems (ADAS) that provides information for assisting driving of a host vehicle or provides assistance for controlling the host vehicle.

Here, ADAS may refer to various types of state-of-the-art driver assistance systems and may include, e.g., autonomous emergency braking (AEB) system, smart parking assistance system (SPAS), blind spot detection (BSD) system, adaptive cruise control (ACC) system, lane departure warning system (LDWS), lane keeping assist system (LKAS), and lane change assist system (LCAS). However, embodiments of the disclosure are not limited thereto.

The radar control device 10 according to the disclosure may be equipped in a manned vehicle which is controlled by the driver aboard or an autonomous vehicle.

The radar control device 10 may receive reception information obtained by detecting an object around the host vehicle, and detect a measurement based on the reception information.

The detected measurement may be classified as a moving object and a stationary object, a first path may be produced by performing curve fitting on the stationary object, and a vehicle driving path may be estimated based on the first path.

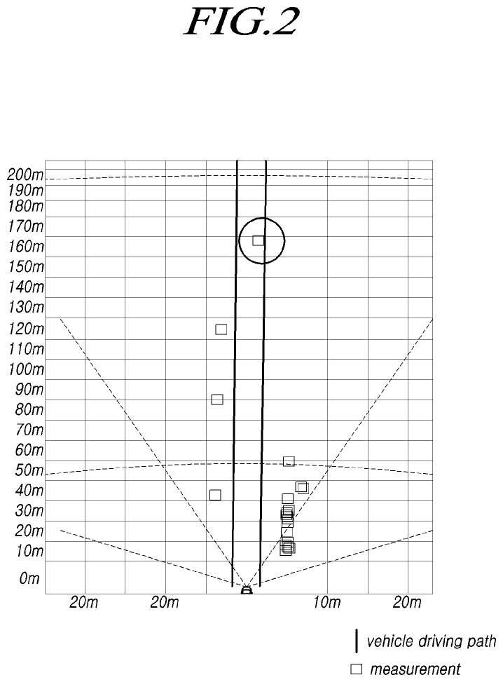

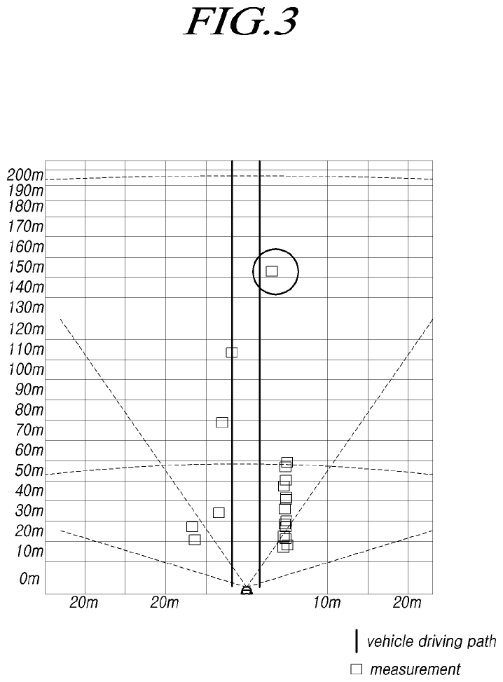

FIGS. 2 and 3 are views illustrating an example of maintaining a control target by a radar control device 10 according to an embodiment.

The radar control device 10 may estimate the vehicle driving path based on the received information and determine whether the detected control target is located on the estimated vehicle driving path.

Referring to FIG. 2, the radar control device 10 may determine that the detected object is located on the vehicle driving path.

Accordingly, the radar control device 10 may set a control target for the detected object, and if the steering control device is performing a smart cruise control function, the radar control device 10 may set criteria such as, e.g., for adjusting the distance or maintaining the speed between the control target and the host vehicle based on the control target.

Conversely, referring to FIG. 3, the radar control device 10 may determine that an object is not detected on the vehicle driving path.

Accordingly, the radar control device 10 may determine that there is no control target and may not set a criterion such as, e.g., for maintaining the speed of the host vehicle.

In this case, the object in front may actually deviate from the lane in which the vehicle is driving, but may deviate from the set vehicle driving path as the object in front enters the curved road.

The disclosure discloses a radar control device and method for maintaining a control target by producing a vehicle driving path reflecting a curved road even when a set control target enters the curved road.

The receiver 110 may receive reception information obtained by sensing an object around the host vehicle every preset period.

In an example, the receiver 110 may receive reception information from a radar sensor mounted to the vehicle.

Here, the radar sensor may include an antenna unit, a radar transmitter, a radar receiver, and the like.

Specifically, the antenna unit may include one or more transmission antennas and one or more reception antennas. Each transmission/reception antenna may be an array antenna including one or more radiation elements connected in series through feeding lines but is not limited thereto.

The antenna unit may include a plurality of transmission antennas and a plurality of reception antennas and may have various array structures depending on the arrayed order and arrayed interval.

The radar transmitter may switch to one of the plurality of transmission antennas included in the antenna unit to transmit transmission signals through the switched transmission antenna or may transmit transmission signals through multiple transmission channels allocated to the plurality of transmission antennas.

The radar transmitter include an oscillation unit that generates transmission signals for one transmission channel allocated to the switched transmission antenna or multiple transmission channels allocated to the plurality of transmission antennas.

The oscillator may include, e.g., a voltage-controlled oscillator (VCO) and an oscillator.

The radar receiver may receive a reception signal, which is reflected by the object, through the reception antenna.

The radar receiver may switch to one of the plurality of reception antennas and receive the reception signal, which is the transmission signal reflected by the target, through the switched reception antenna or receive the reception signal through multiple reception channels allocated to the plurality of reception antennas.

The radar receiver may include, e.g., a low noise amplifier (LNA) that low-noise amplifies the reception signal, which is received through one reception channel allocated to the switched reception antenna or through multiple reception channels allocated to the plurality of transmission antennas, a mixer that mixes the low-noise amplified reception signal, an amplifier that amplifies the mixed reception signal, and an analog-digital converter (ADC) that converts the amplified reception signal into a digital signal to thereby generate reception information.

In another example, the receiver 110 may control the above-described radar to output a control signal to be transmitted to the radar, and receive a reception information from the radar.

The producer may detect a measurement based on the reception information, classify the detected measurement as a moving object and a stationary object, and produce a first path by performing curve fitting on the stationary object.

The producer may calculate a measurement by performing a fast Fourier transform (FFT) on the reception information.

Specifically, the producer 120 may convert the reception signal into the distance (range)-time index by performing primary FFT on the frequency and convert it into the range-velocity (Doppler) index by performing secondary FFT on the time.

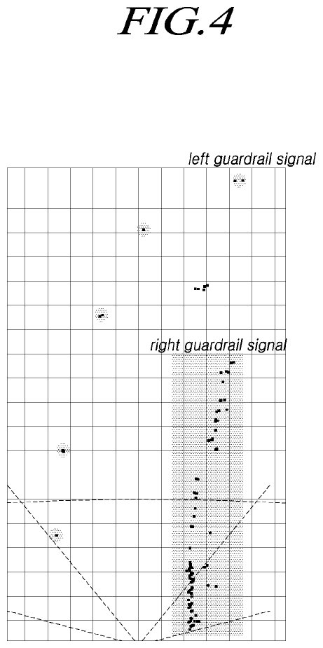

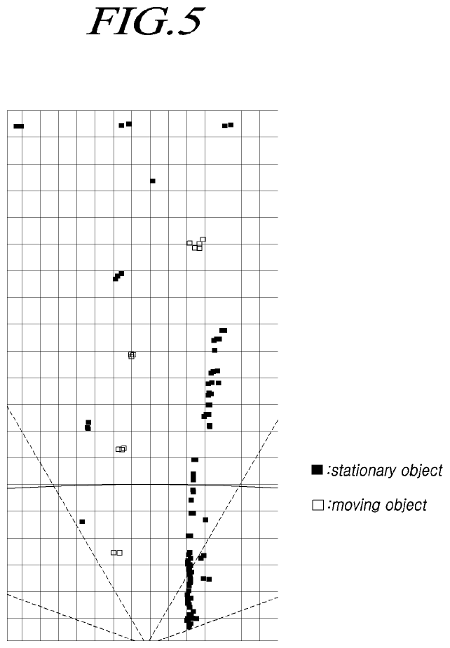

FIG. 4 is a view illustrating an example of classifying a calculated measurement as a moving object and a stationary object according to an embodiment. FIG. 5 is a view illustrating a determination result of a stationary object according to an embodiment.

Referring to FIG. 4, the producer 120 may classify a measurement as a moving object and a stationary object based on a relative velocity between the host vehicle and the measurement.

Specifically, the producer 120 may calculate the longitudinal velocity of the measurement based on the measurement angle and velocity included in the measurement and compare the same with the velocity of the host vehicle to classify the measurement as the stationary object and the moving object.

The above classification criteria may be expressed by Equation 2 below.

$${v}_{x} = {v}_{r} * cos ( θ ) \qquad [ Equation 1 ]$$

$$\vert V - {v}_{x} \vert < α$$

Here, V is the velocity of the host vehicle, θ is the signal measurement angle, and vᵣ is the velocity of the measurement.

The longitudinal velocity vₓ of the measurement may be calculated by multiplying the velocity of the measurement by the cosine value of the signal measurement angle θ.

Here, the longitudinal direction of the measurement and the traveling direction of the vehicle may be the same as each other.

When the size difference between the velocity of the host vehicle and the longitudinal velocity of the measurement is less than a reference value α, the producer 120 may classify the vehicle as a stationary object.

Here, the reference value α is a value close to 0 and may be set to vary according to the distance to the measurement and the velocity of the host vehicle.

If the surroundings of the vehicle are determined based on the above-described moving object and the stationary object, the producer 120 may distinguish the right guardrail signal and the left guardrail signal as shown in FIG. 5.

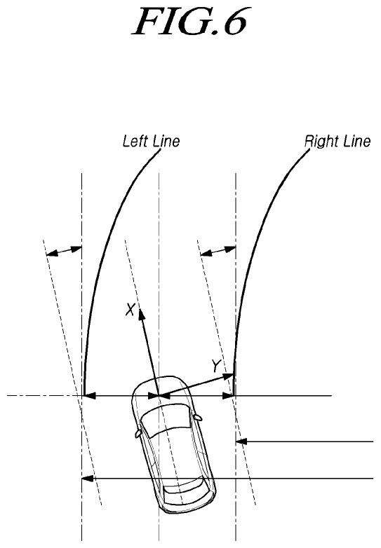

FIG. 6 is a view illustrating a curve fitting according to an embodiment.

Referring to FIG. 6, the producer 120 may perform curve fitting on the measurement.

Specifically, the curve fitting may be expressed by Equation 2 below as a polynomial curve model.

$$Line Model : Y = {C}_{0} + {C}_{1} X + {C}_{2} {X}^{2} + {C}_{3} {X}^{3} \qquad [ Equation 2 ]$$

Here, C₀ may mean the line lateral offset, C₁ may mean the lane heading angle, C₂ may mean the line curvature, and C₃ may mean the line curvature derivative.

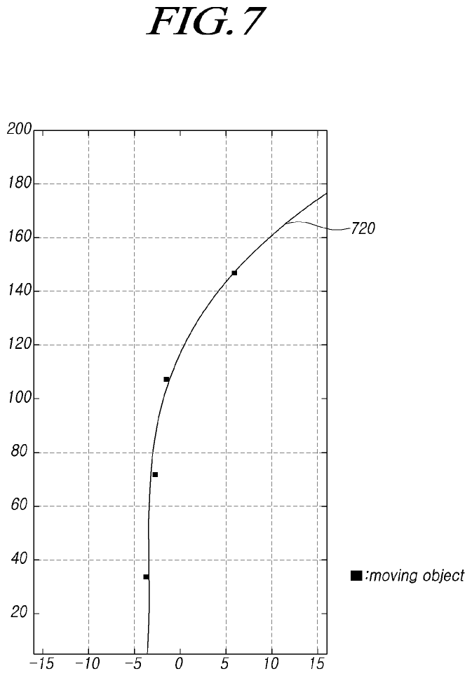

FIG. 7 is a view illustrating an example of producing a second path 720 according to an embodiment.

Referring to FIG. 7, the producer 120 may further produce a second path 720 by performing curve fitting on the moving object.

The producer 120 may divide an area around the host vehicle into a left area and a right area with respect to the second path 720 and produce the first path 710 to be included in any one area based on the stationary object.

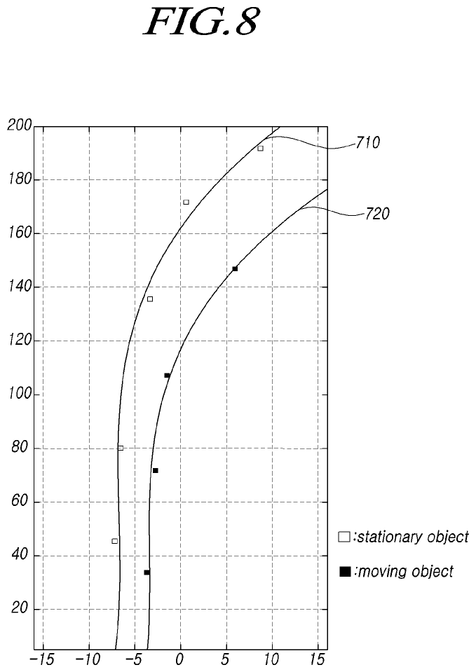

FIG. 8 is a view illustrating an example of producing a first path 710 included in an area divided by a second path 720 according to an embodiment.

Referring to FIG. 8, it may be identified that the first path 710 of FIG. 8 is produced to be included in the left area of the left area and the right area divided by the second path 720.

The producer 120 may produce the first path 710 in the area including the stationary object detected at the farthest position from the host vehicle.

For example, in the case of a curved road bent to the right, the signal reflected by the left guardrail may be the stationary object detected at the farthest position.

The producer 120 may produce the first path 710 in the area including the stationary object detected at the position closest to the host vehicle.

The stationary object detected at the position closest to the host vehicle may be typically a guardrail.

In the case of four round-trip lanes, if the host vehicle is driving in the left lane, the stationary object detected at the closest position may be the left guardrail separating the center line, and if the host vehicle is driving in the right lane, the stationary object detected at the closest position may be the right guardrail.

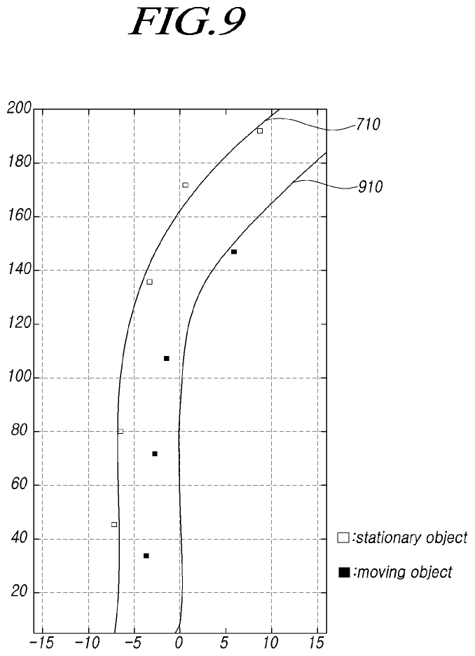

FIG. 9 is a view illustrating an example of producing a third path 910 according to an embodiment.

Referring to FIG. 9, the producer 120 may produce a third path 910 spaced apart from the first path 710 by a predetermined lateral gap.

For example, the predetermined lateral gap may be a lateral gap between the first path 710 and the location of the host vehicle.

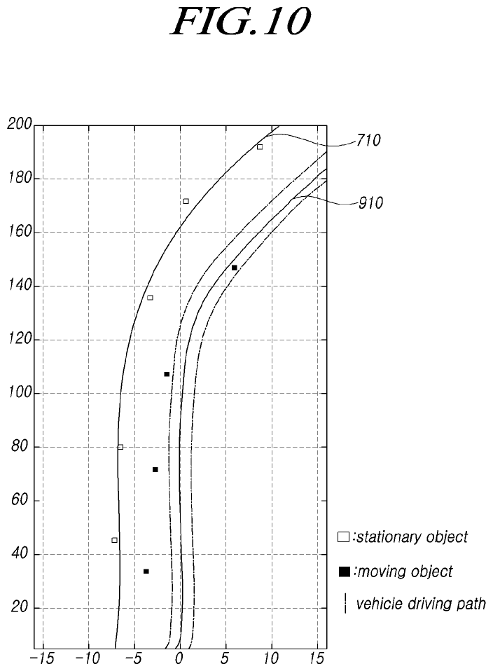

FIG. 10 is a view illustrating an example of estimating a vehicle driving path according to an embodiment.

Referring to FIG. 10, the estimator 130 may estimate a vehicle driving path based on the first path 710.

Specifically, the estimator 130 may estimate a vehicle driving path having a width of the host vehicle with the third path 910 centered.

The radar control device 10 may further include a setter 140 setting the moving object as a control target only when the moving object is located on the vehicle driving path.

Further, when a plurality of moving objects are located on the vehicle driving path, the setter 140 may set the moving object closest to the third driving path as the control target.

In other words, as the vehicle driving path has the same interval along the first path 710, when the control target enters the curved road, the moving object corresponding to the control target is located on the estimated vehicle driving path, and the radar control device 10 may determine that the control target is maintained.

According to an embodiment, the radar control device 10 may be implemented as an electronic control unit (ECU).

The ECU may include at least one or more of one or more processors, a memory, a storage unit, a user interface input unit, or a user interface output unit which may communicate with one another via a bus.

The computer system may also include a network interface for accessing a network.

The processor may be a central processing unit (CPU) or semiconductor device that executes processing instructions stored in the memory and the storage unit.

The memory and the storage unit may include various types of volatile/non-volatile storage media. For example, the memory may include a read only memory (ROM) and a random access memory (RAM).

Described below is a radar control method using the radar control device 10 capable of performing the above-described embodiments of the disclosure.

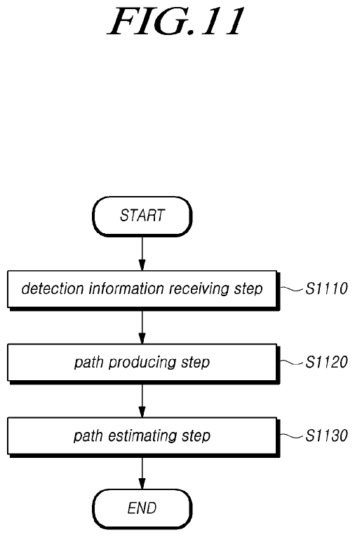

FIG. 11 is a flowchart illustrating a radar control method according to an embodiment of the disclosure.

Referring to FIG. 11, a radar control method according to the disclosure may include a detection information receiving step S1110 receiving reception information obtained by detecting an object around a host vehicle, a path producing step S1120 detecting a measurement based on the reception information, classifying the measurement as a moving object and a stationary object, and performing a curve fitting on the stationary object to produce a first path, and a path estimating step S1130 estimating a vehicle driving path based on the first path.

The path producing step S1120 may calculate a measurement by performing fast Fourier transform (FFT) on reception information.

The path producing step S1120 may classify the measurement as a stationary object if the difference between the longitudinal velocity of the measurement and the velocity of the host vehicle is a predetermined velocity or less.

The longitudinal velocity of the measurement may be calculated using the measurement detection angle included in the measurement.

The path producing step S1120 may perform curve fitting on the moving object to further produce a second path 720 and produce the first path 710 based on the second path 720.

The path producing step S1120 may divide an area around the host vehicle into a left area and a right area with respect to the second path 720 and produce the first path 710 to be included in any one area based on the stationary object.

The path producing step S1120 may produce the first path 710 in the area including the stationary object detected at the farthest position from the host vehicle.

The path producing step S1120 may produce the first path 710 in the area including the stationary object detected at the position closest to the host vehicle.

The path producing step S1120 may produce a third path 910 spaced apart from the first path 710 by a predetermined lateral gap.

The path estimating step S1130 may estimate a vehicle driving path having a width of the host vehicle with the third path 910 centered.

The radar control method may further include a target setting step setting the moving object as a control target only when the moving object is located on the vehicle driving path.

When a plurality of moving objects are located on the vehicle driving path, the target setting step may set the moving object closest to the third driving path as the control target.

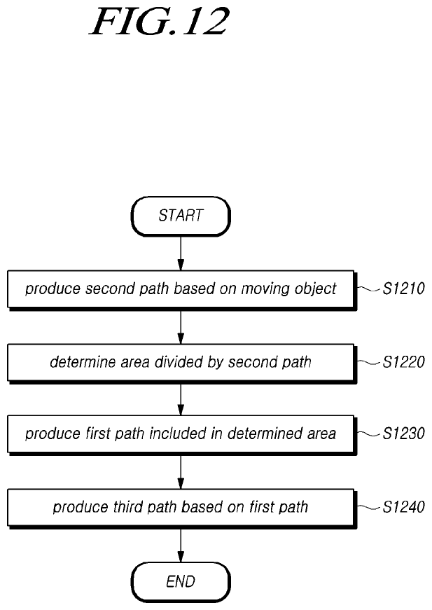

FIG. 12 is a flowchart illustrating, in greater detail, step S1120 according to an embodiment.

Referring to FIG. 12, the radar control device 10 may produce a second path 720 based on a moving object (S1210).

The radar control device 10 may classify the moving object and the stationary object based on the longitudinal velocity of the measurement and the velocity of the host vehicle.

The radar control device 10 may determine an area divided by the second path 720 (S1220).

The surroundings of the host vehicle may be divided into a left area and a right area by the second path 720.

The radar control device 10 may determine any one area of the areas divided based on the moving object and the stationary object.

The radar control device 10 may produce a first path 710 to be included in the determined area (S1230).

The radar control device 10 may produce a third path 910 based on the produced first path 710 (S1240).

For example, the third path 910 may be produced to be spaced apart from the first path 710 by a predetermined lateral gap.

Here, the predetermined lateral gap may be a lateral gap from the center of the host vehicle to the first path 710.

As described above, according to the disclosure, the radar control device and method may set a preceding vehicle as a control target in a situation where accuracy of estimation of a vehicle driving path is deteriorated, such as in a long-distance curved road, only with a detection signal of a radar sensor.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A radar control device, comprising:
a receiver receiving reception information obtained by detecting an object around a host vehicle;
a producer detecting a measurement based on the reception information, classifying the measurement as a moving object and a stationary object, and performing a curve fitting on the stationary object to produce a first path; and
an estimator estimating a vehicle driving path based on the first path.

2. The radar control device of claim 1, wherein the producer further produces a second path by performing the curve fitting on the moving object and produces the first path based on the second path.

3. The radar control device of claim 2, wherein the producer divides an area around the host vehicle into a left area and a right area with respect to the second path and produces the first path to be included in any one area based on the stationary object.

4. The radar control device of claim 3, wherein the producer produces the first path in an area including the stationary object detected at a farthest position from the host vehicle.

5. The radar control device of claim 3, wherein the producer produces the first path in an area including the stationary object detected at a closest position to the host vehicle.

6. The radar control device of claim 1, wherein the producer produces a third path spaced apart from the first path by a predetermined lateral gap, and
wherein the estimator estimates the vehicle driving path having a width of the host vehicle with the third path centered.

7. The radar control device of claim 6, further comprising
a setter setting the moving object as a control target only when the moving object is located on the vehicle driving path.

8. The radar control device of claim 7, wherein the setter sets a moving object closest to the third path as the control target if a plurality of moving objects are located on the vehicle driving path.

9. The radar control device of claim 1, wherein the producer classifies the measurement as the stationary object if a difference between a longitudinal velocity of the measurement and a velocity of the host vehicle is smaller than a predetermined velocity.

10. The radar control device of claim 1, wherein the producer calculates the measurement by performing fast Fourier transform (FFT) on the reception information.

11. A radar control method, comprising:
a detection information receiving step receiving reception information obtained by detecting an object around a host vehicle;
a path producing step detecting a measurement based on the reception information, classifying the measurement as a moving object and a stationary object, and performing a curve fitting on the stationary object to produce a first path; and
a path estimating step estimating a vehicle driving path based on the first path.

12. The radar control method of claim 11, wherein the path producing step further produces a second path by performing the curve fitting on the moving object and produces the first path based on the second path.

13. The radar control method of claim 12, wherein the path producing step divides an area around the host vehicle into a left area and a right area with respect to the second path and produces the first path to be included in any one area based on the stationary object.

14. The radar control method of claim 13, wherein the path producing step produces the first path in an area including the stationary object detected at a farthest position from the host vehicle.

15. The radar control method of claim 13, wherein the path producing step produces the first path in an area including the stationary object detected at a closest position to the host vehicle.

16. The radar control method of claim 11, wherein the path producing step produces a third path spaced apart from the first path by a predetermined lateral gap, and
wherein the path estimating step estimates the vehicle driving path having a width of the host vehicle with the third path centered.

17. The radar control method of claim 16, further comprising
a target setting step setting the moving object as a control target only when the moving object is located on the vehicle driving path.

18. The radar control method of claim 17, wherein the target setting step sets a moving object closest to the third path as the control target if a plurality of moving objects are located on the vehicle driving path.

19. The radar control method of claim 11, wherein the path producing step classifies the measurement as the stationary object if a difference between a longitudinal velocity of the measurement and a velocity of the host vehicle is smaller than a predetermined velocity.

20. The radar control method of claim 11, wherein the path producing step calculates the measurement by performing fast Fourier transform (FFT) on the reception information.
